(19) United States
(12) Patent Application Publication
(10) Pub. No.: US 2009/0098837 A1
(43) Pub. Date: Apr. 16, 2009

(54) TUNER MOUNTING METHOD, TUNER DEVICE, AND CAR STEREO DEVICE

(76) Inventors: Satoshi KOHNO, Akita (JP); Takumi Suzuki, Akita (JP); Toshihiko Inaba, Akita (JP); Kyuichi Sato, Akita (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/251,970

(22) Filed: Oct. 15, 2008

(30) Foreign Application Priority Data
Oct. 16, 2007 (JP) P2007-268648

(51) Int. Cl. H04W 99/00

(52) U.S. Cl. 455/90.3

(57) ABSTRACT

A tuner module is adapted to be retrofitted into an opening formed on a cabinet of a car stereo device.

An attachment member is provided on the tuner module and adapted to be used to attach the tuner device to the cabinet when the tuner module is retrofitted into the opening.

### BACKGROUND

The present invention relates to a tuner mounting method for mounting a tuner module for a radio receiver onto the cabinet of a car stereo device, and in particular to a tuner device that allows retrofitting, to the cabinet of a car stereo device, of a tuner module suitable for a vehicle-mounted digital radio receiver capable of receiving radio waves coming from an artificial satellite (hereinafter referred to as the “satellite waves”) or radio waves propagated over the ground (hereinafter referred to as the “ground waves”) and listening to digital radio broadcasting.

SDARS (Satellite Digital Audio Radio Service) is a digital broadcasting service using a satellite (hereinafter referred to as the “SDARS satellite”) offered in the United States of America. That is, in the United States of America, digital radio receivers have been developed and put in the actual use that are capable of receiving satellite waves from an SDARS satellite or ground waves and listening to digital radio broadcasting. Recently, in the United States of America, two broadcast stations, XM and SIRIUS, provide radio broadcast programs nationwide on total 250 or more channels. The digital radio receiver is generally mounted on a mobile unit (mobile station) such as an automobile and is capable of listening to radio broadcasting by receiving radio waves (SDARS signals) of around 2.3 GHz. That is, the digital radio receiver is a radio receiver capable of listening to mobile broadcasting. The frequency of a received radio wave (SDARS signal) is around 2.3 GHz so that the resulting receive wavelength (resonant wavelength) λ is about 128 mm. A ground radio wave used is generated from a satellite radio wave. A satellite radio wave is temporarily received by an earth station and, with the frequency slightly shifted, transmitted again as a linear polarized wave. In other words, the satellite radio wave is a circular polarized wave while the ground radio wave is a linear polarized wave. As an antenna for SDARS, a planar antenna such as a patch antenna is used.

An antenna device for XM satellite radio broadcasting receives circular polarized radio waves from two geostationary satellites and receives radio waves by way of a ground linear polarization facility while located in a blind zone. On the other hand, an antenna device for SIRIUS satellite radio broadcasting receives circular polarized radio waves from three orbiting satellites (synchronous type) and receives radio waves by way of a ground linear polarization facility while located in a blind zone.

In this way, digital radio broadcasting uses radio waves of approximately 2.3 GHz (SDARS signals) so that an antenna device receiving the SDARS signal must be arranged outdoors. Thus, in order to mount a digital radio receiver on a mobile unit (mobile station) such as an automobile, such an antenna device must be mounted on the roof of the mobile unit (mobile station).

Such an antenna for automobiles and a receiver main unit (head unit) arranged in the cabin of an automobile are electrically connected to each other with an extension cable. The head unit serves as an external device.

A receiver system for receiving such satellite waves or ground waves includes an antenna part (antenna device) and a tuner (satellite radio receiver module). The antenna part (antenna device) receives satellite waves or ground waves and outputs high-frequency receive signals. The tuner (satellite radio receiver module) demodulates the receive signals and outputs sound signals.

Electronic components constituting such a tuner are typically mounted on a printed circuit board and accommodated in a metallic case also serving as a shield (for example, refer to Patent Document 1).

An exemplary configuration of a satellite digital receiver module will be described with reference FIG. 8. The satellite digital receiver module includes an antenna 101, a tuner 102, a signal demodulator 103, a channel demodulator 104, a sound decoder 105, a data decoder 106, a controller 107, and an operation part 108 (for example, refer to Patent Document 2).

An applicant who wishes to listen to the above satellite radio broadcasting (hereinafter referred to as the “satellite radio applicant”) either has an antenna for automobiles (antenna for SDARS) and a satellite radio receiver module (head unit) mounted on a vehicle he/she has just purchased, or purchases products available on the market (an antenna for SDARS and a satellite radio receiver module) and retrofits the products to his/her vehicle. In view of the above, it is necessary to incorporate a satellite radio receiver module (tuner module) into a car stereo device.

As another retrofitting method, the applicant may purchase a handy receiver incorporating an FM transmitter. In this example, SDARS signals received by an antenna for SDARS are radiated (transmitted) by way of FM signals for the applicant to listen to satellite radio broadcasting (for example, refer to Patent Document 3).

The car stereo device herein refers to a stereo device as an audio device mounted on an automobile, the stereo device designed to receive FM signals or AM signals and play a CD or a DVD by using a separate amplifier and speakers thus allowing a listener to determine the location of sound sources and enjoy stereophonic representation as well as presence.

[Patent Document 1] JP-A-6-209268

[Patent Document 2] JP-A-2002-344335

[Patent Document 3] JP-A-2005-244694

### DISCLOSURE OF THE INVENTION

[Problems that the Invention is to Solve]

In the retrofitting approach described in Patent Document 3, both a receiver and an antenna are mounted on a dashboard, which results in poor appearance/operability.

In a case where a satellite radio receiver module (tuner module) is incorporated in a car stereo device, the development efficiency and production efficiency of a car stereo manufacturer will be substantially lowered. That is because: the scale of the number of satellite radio receiver module mounting car stereo devices as genuine mounted products is small while vehicles on which such car stereo devices are mounted are of various types, and under such circumstances, a car stereo manufacturer must develop and produce anew such satellite radio receiver module mounting car stereo devices.

### SUMMARY

It is therefore one advantageous aspect of the invention to provide a tuner mounting method, a tuner device, and a car stereo device that facilitate retrofitting of a satellite radio receiver module (tuner module) to a car stereo device without reducing the development efficiency and production efficiency of a car stereo device.

According to one aspect of the invention, there is provided a tuner device comprising:

a tuner module, adapted to be retrofitted into an opening formed on a cabinet of a car stereo device; and

an attachment member, provided on the tuner module and adapted to be used to attach the tuner device to the cabinet when the tuner module is retrofitted into the opening.

The tuner device may be configured such that: the tuner module is box-shaped; and the attachment member comprises: a cover defining at least a part of outer faces of the tuner module; and a piece extended from the cover.

The tuner device may be configured such that: the piece is formed with a through hole and adapted to be placed at such a position that the through hole opposes a screw hole formed on the cabinet; and the through hole is adapted to receive a screw to be screwed into the screw hole.

The tuner device may be configured such that: the cover comprises an outer face adapted to be placed on a plane which is parallel to a face of the cabinet formed with the opening; and the piece is extended from the outer face.

The tuner device may further comprise: a connector, attached to the tuner module and at least a part thereof is disposed on the outer face.

The tuner device may further comprise: a connector pin, attached to the tuner module and extending in a direction orthogonal to a circuit board disposed within cabinet when the tuner module is retrofitted into the opening.

According to one aspect of the invention, there is provided a car stereo device, comprising:

a cabinet formed with an opening; and

a tuner device comprising;
a tuner module retro-fitted into the opening; and
a first attachment member provided on the tuner module and attaching tuner module to the cabinet.

The car stereo device may further comprise: a second attachment member formed on the cabinet and coupled with the first attachment member.

The car stereo device may be configured such that: the first attachment member includes a piece extended from the tuner module and formed with a through hole; and the second attachment member includes a screw hole and a screw screwed into the screw hole through the through hole.

The car stereo device may further comprise: a circuit board extending in a first direction within the cabinet; and a connector pin provided with the tuner device and electrically connected to the circuit board, the connector pin extending in a second direction orthogonal to the first direction.

The car stereo device may be configured such that: a cabinet formed with an opening adapted to receive a tuner module of a tuner device in a retrofitting manner.

According to one aspect of the invention, there is provided a a method for mounting a tuner device onto a car stereo device, comprising:

providing the above tuner device and the above car stereo device;

retrofitting the tuner module into the opening; and

retaining the tuner module on the cabinet.

### BRIEF DESCRIPTION OF THE DRAWINGS

FIG. 1 is a perspective view showing the schematic configuration of a tuner module assumed in a case where the invention is applied to a tuner device in a vehicle-mounted digital radio receiver.

FIG. 2 is a perspective view of a tuner device according to a first embodiment of the invention.

FIG. 3 is a partial schematic perspective view showing a part of the cabinet of a car stereo device to which the tuner device shown in FIG. 2 is retrofitted.

FIG. 4 is a perspective view of an arrangement where the tuner device shown in FIG. 2 is mounted on the cabinet of the car stereo device shown in FIG. 3.

FIG. 5 is a perspective view of a tuner device according to a second embodiment of the invention.

FIG. 6 is a partial schematic perspective view showing a part of the cabinet of a car stereo device to which the tuner device shown in FIG. 5 is retrofitted.

FIG. 7 is a perspective view of an arrangement where the tuner device shown in FIG. 5 is mounted on the cabinet of the car stereo device shown in FIG. 6.

FIG. 8 is a block diagram showing the configuration of a satellite radio receiver module as an example of a digital radio receiver.

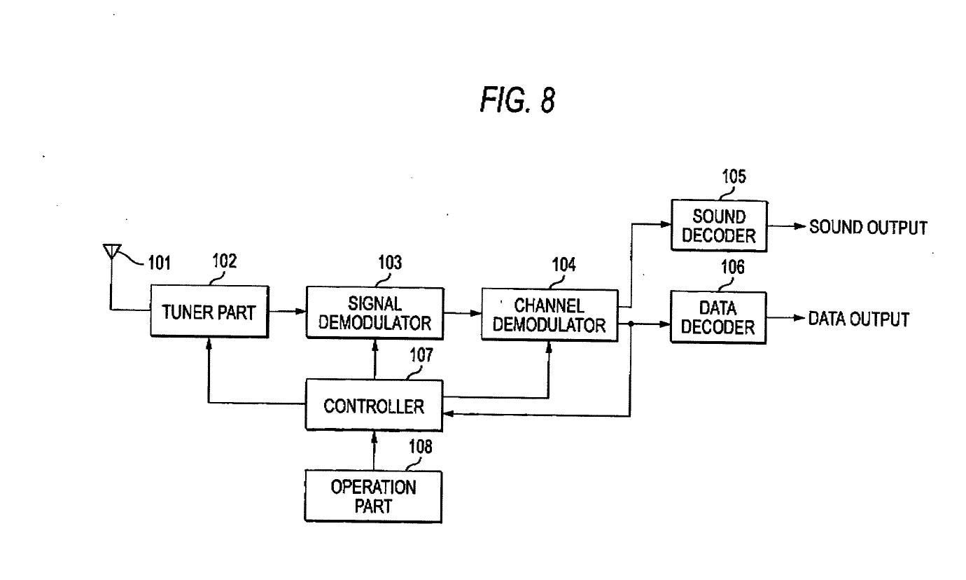

### DETAILED DESCRIPTION OF EXEMPLIFIED EMBODIMENTS

Exemplified embodiments of the invention will be described below in detail with reference the accompanying drawings.

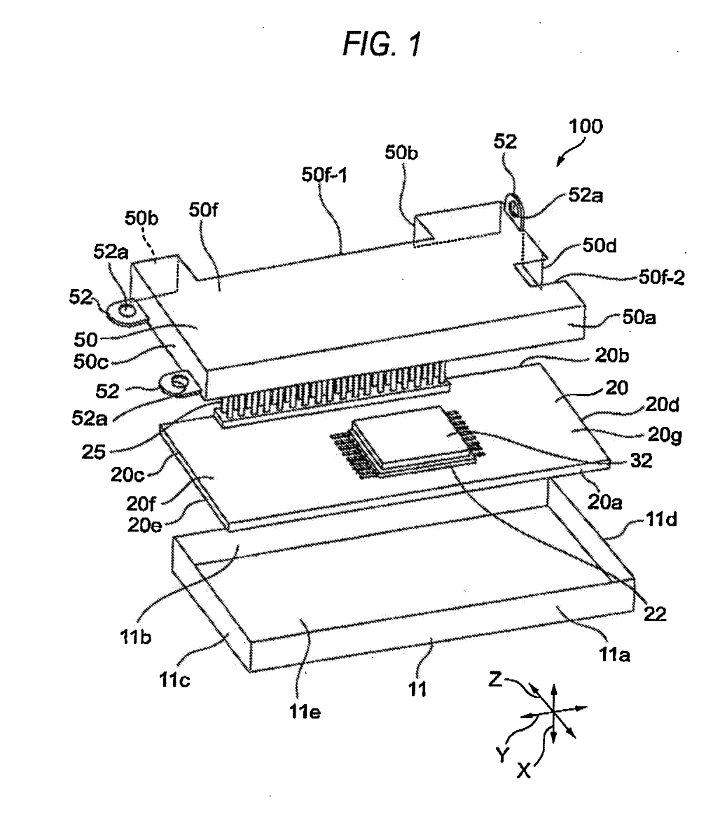

First, a tuner module 100 to which the tuner device of the invention is applied will be described with reference FIG. 1. In FIG. 1, a front-rear direction (depth direction, thickness direction) is represented by an X-axis direction, a right-left direction (lateral direction, width direction) by a Y-axis direction, and a up-down direction (height direction) by a Z-axis direction. The exemplary tuner module 100 in FIG. 1 is mounted so as to elongate in a direction parallel to the major face of the main substrate of the car stereo device. As will be explained later, the main substrate of the car stereo device is equipped so as to extend in the vertical direction. Note that the invention is also applicable to an arrangement where the tuner module is mounted so as to elongate in a direction orthogonal to the major face of the main substrate of the car stereo device.

A tuner, a demodulator, a sound decoder, a data decoder, and a controller for controlling these components among the components of a vehicle-mounted digital radio receiver are mounted on a single printed circuit board 20, which is accommodated in a metallic case (described later). This arrangement is herein referred to as a “tuner module”.

A tuner module 100 includes a metallic case (sheet-metal case; shielding case) and a printed circuit board 20. The metallic case (sheet-metal case; shielding case) is composed of a first case 11 and a second case 50. As described later, the illustrated tuner device is of a type in which the tuner module 100 is mounted so as to elongate in a direction parallel to the major face of the main substrate of a car stereo device extending in the vertical direction. Thus, the first case 11 is called a front case and the second case 50 a rear case.

As described later, the second case (rear case) 50 is also called an attachment case.

In a case where the tuner module 100 is mounted so as to elongate in a direction orthogonal to the major face of the main substrate of the car stereo device, the first case 11 and the second case (attachment case) 50 are respectively used as an upper case and a lower case. In this case, the arrangement of connector pins (described later) to be mounted on the printed circuit board 20 is also different.

In this embodiment, both the front case 11 and the rear case (attachment case) 50 are formed by bending metallic plates.

The front case 11 is box-shaped in which a rear side is opened. That is, the front case 11 includes a front plate part 11e extending parallel to a Y-Z plane substantially defined by the Y-axis direction and the Z-axis direction. The front case 11 includes a lower plate part 11a and an upper plate part 11b opposed to each other in vertical direction and a right plate part 11c and a left plate part 11d opposed to each other in the Y-axis direction. A printed circuit board 20 described later is accommodated in the front case 11.

The rear case (attachment case) 50 is box-shaped in which a front side is opened. That is, the rear case (attachment case) 50 includes a rear plate part 50f extending parallel to the Y-Z plane substantially defined by the Y-axis direction and the Z-axis direction. The rear case 50 includes a lower plate part 50a and an upper plate part 50b opposed to each other in vertical direction and a right plate part 50c and a left plate part 50d opposed to each other in the Y-axis direction. The rear case (attachment case) 50 serves as a lid for an assembly of the printed circuit board 20 and the front case 11.

The printed circuit board 20 has an almost rectangular shape and extends parallel to the Y-Z plane defined by the Y-axis direction and the Z-axis direction. The printed circuit board 20 includes a lower side 20a and an upper side 20b opposed to each other in the Z-axis direction and a right side 20c and a left side 20d opposed to each other in the Y-axis direction. The printed circuit board 20 includes a front face 20e and a rear face 20f opposed to each other in the X-axis direction. The front case 11 is arranged on the side of the front face 20e of the printed circuit board 20. The rear case (attachment case) 50 is arranged on the side of the rear face 20f.

The printed circuit board 20 is accommodated in the space between the front case 11 and the rear case (attachment case) 50, except a section that requires electric connection to outside (described later), thus providing a shield. That is, the printed circuit board 20 is fixed while sandwiched by the front case 11 and the rear case (attachment case) 50 by using a plurality of screws (not shown).

On the rear face 20f of the printed circuit board 20 are mounted a first IC component (not shown) as a main component of the tuner and a second IC component 22 as a main component of the demodulator. On the front face 20e of the printed circuit board 20 is mounted a third IC component (not shown) as a main component of the controller.

On the upper face (entire surface in this example) of the second IC component 22 or on the inner face of the metallic case (inner wall of the rear plate part 50f of the rear case 50) corresponding thereto is bonded a heat conductive sheet 32. The heat conductive sheet 32 adheres to the second IC component 22 and the inner wall of the rear plate part 50f of the rear case 50 by way of surface contact in order to improve heat conduction. The material of a heat conductive sheet may be silicon rubber, acrylic rubber, or graphite.

As shown in FIG. 1, a connector pin 25 inserted in the wiring pattern of the main substrate (not shown) is mounted on the upper side 20b of the printed circuit board 20. The rear plate part 50f of the rear case (attachment case) 50 includes a cutout 50f-1 for receiving a connector, in the position of the lower plate part 50b corresponding to the mounting position of the connector pin 25.

The printed circuit board 20 includes, in the lower left corner thereof, an RF input part 209 for inputting a radio-frequency (RF) receive signal coming from an antenna device (not shown). The rear plate part 50f of the rear case (attachment case) 50 includes a rectangular rear cutout 50f-2 in the position of the left plate part 50d corresponding to the RF input part 209. As described later, an RF connector is connected to the RF input part 209.

Namely, the tuner module 100 has the shape of a substantially rectangular solid having six faces (that is, a front face, a rear face, a right side face, a left side face, an upper face, and a lower face). The front face of the tuner module 100 is composed of the front plate part 11e of the front case 11. The rear face of the tuner module 100 is composed of the rear face part 50f of the rear case (attachment case) 50. The right side face of the tuner module 100 is composed of the right plate part 50c of the rear case (attachment case) 50. The left side face of the tuner module 100 is composed of the left plate part 50d of the rear case (attachment case) 50. The upper face of the tuner module 100 is composed of the upper plate part 11b of the front case 11 and the upper plate part 50b of the rear case (attachment case) 50. The lower face of the tuner module 100 is composed of the lower plate part 50a of the rear case (attachment case) 50.

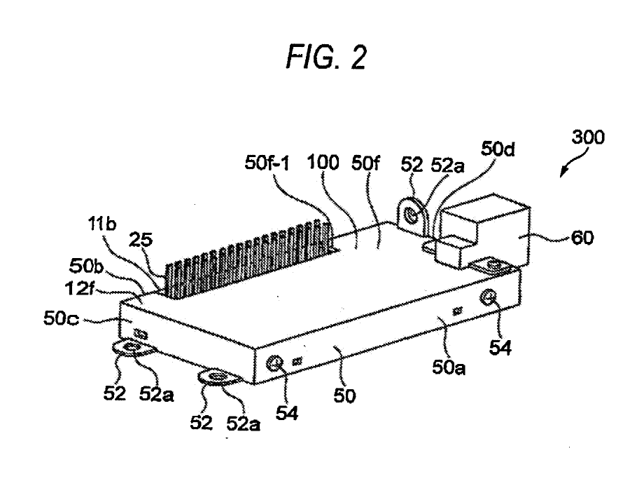

With reference FIG. 2, a tuner device 300 according to the first embodiment of the invention will be described. The illustrated tuner device 300 is composed of a tuner module 100 including the attachment case 50 shown in FIG. 1, a plurality of attachment pieces 52 extending from the attachment case 50 and mounting the tuner device 300 onto the cabinet (described later) of the car stereo device, and an RF connector 60.

As described the above, the attachment case 50 defines the rear face, right side face, left side face, upper face, and lower face of the tuner module 100. That is, the attachment case 50 is composed of a rear plate part 50f defining the rear face of the tuner module 100, a right plate part 50c defining the right side face, a left plate part 50d defining the left side face, an upper plate part 50b defining the upper face, and a lower plate part 50a defining the lower face. In other words, the attachment case 50 defines the tuner module 100 except the front face of the tuner module 100.

Although the attachment case 50 covers five faces of the tuner module 100 in this embodiment, the attachment case 50 may define at least one face thereof.

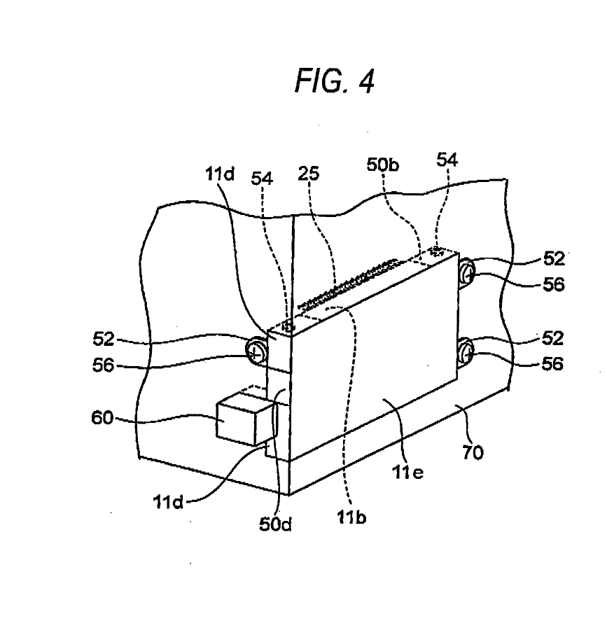

The attachment case 50 is mounted onto the tuner module 100 by using four screws 54. Two screws 54 are screwed into the lower face of the tuner module 100 from the lower plate part 50a of the attachment case 50. The remaining two screws 54 are screwed into the upper face of the tuner module 100 from the upper plate part 50b of the attachment case 50, as described later with FIG. 4.

The plurality of attachment pieces 52 shown in the drawings are arranged in three sections on the attachment case 50. Two attachment pieces 52 extend rightward from the right plate part 50c of the attachment case 50. The remaining one attachment metal piece 52 extends rearward from the rear plate part 50f of the attachment case 50. These attachment pieces 52 include through holes 53a for passing the screw parts of attachment screws.

The RF connector 60 is mounted on the tuner module 100 while protruding leftward in the lower left section of the tuner module 100 (in a position close to the left plate part 50d).

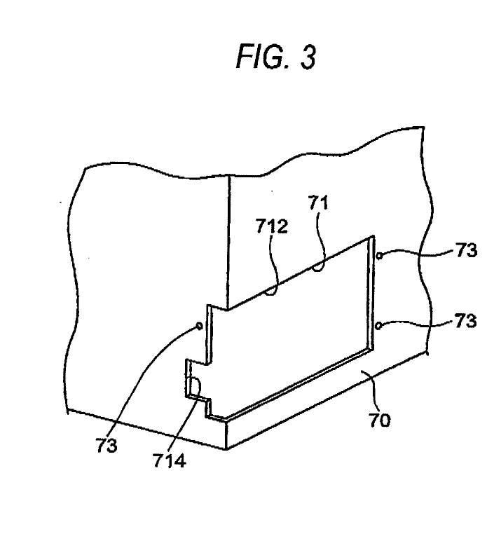

FIG. 3 is a partial schematic perspective view showing a part of the cabinet 70 of the car stereo device to which the tuner device 300 shown in FIG. 2 is retrofitted. The cabinet 70 of the car stereo device includes a slot 71 into which the tuner device 300 is inserted. That is, the slot 71 is composed of a cover inserting slot 712 having a shape corresponding to the external shape of the attachment case 50 and a connector inserting slot 714 having a shape corresponding to the external shape of the RF connector 60. The cabinet 70 of the car stereo device includes three screw holes 73 bored in positions corresponding to the three attachment pieces 52 and into which attachment screws described later are screwed.

FIG. 4 is a perspective view of an arrangement where the tuner device 300 shown in FIG. 2 is mounted on the cabinet 70 of the car stereo device shown in FIG. 3. The tuner device 300 is retrofitted to the cabinet 70 of the car stereo device by screwing three attachment screws 56 into three screw holes 73 in the positions of three attachment pieces 52 while the tuner device 300 is inserted in the slot 71 on the cabinet 70 of the car stereo device. At that time, the connector pin 25 of the tuner module 100 is electrically connected to the major face of the main substrate (not shown) extending in the vertical direction within the cabinet 70 of the car stereo device.

In view of the above, a combination of the attachment case 50 and the three attachment pieces 52 serves as a member for mounting the tuner device 300 onto the cabinet 70 of the car stereo device while the tuner device 300 is inserted in the slot 71.

In this way, only the tuner device (satellite radio receiver module) 300 can be retrofitted to the cabinet 70 of the car stereo device. This enhances the development efficiency and production efficiency of a car stereo device compared with a related-art car stereo device in which a satellite radio receiver module is incorporated in advance. This is because it is not necessary to develop/produce various types of car stereo devices. Moreover, after purchasing an automobile, the user has only to purchase an antenna for SDARS and a tuner device (satellite radio receiver module) 300 in order to listen to satellite radio broadcasting. This eliminates the need for purchasing a whole car stereo device anew.

A plurality of attachment screws 56 are used as fastening members for fastening the tuner device 300 onto the cabinet 70. This causes the removal of the tuner device 300 from the cabinet 70 to be facilitated.

Although a plurality of attachment screws 56 are used as fastening members for fastening the tuner device 300 onto the cabinet 70 in the first embodiment of the invention, the fastening member is not limited to a screw but various fastening means such as an adhesive may be used.

Although the tuner device 300 including a tuner module 100 mounted so as to elongate in a direction parallel to the major face of the main substrate extending in the vertical direction in the cabinet 70 of the car stereo device has been described in the first embodiment of the invention, the invention is also applicable to a tuner device including a tuner module mounted so as to elongate in a orthogonal to the major face of the main substrate extending in the vertical direction in the cabinet 70 of the car stereo device.

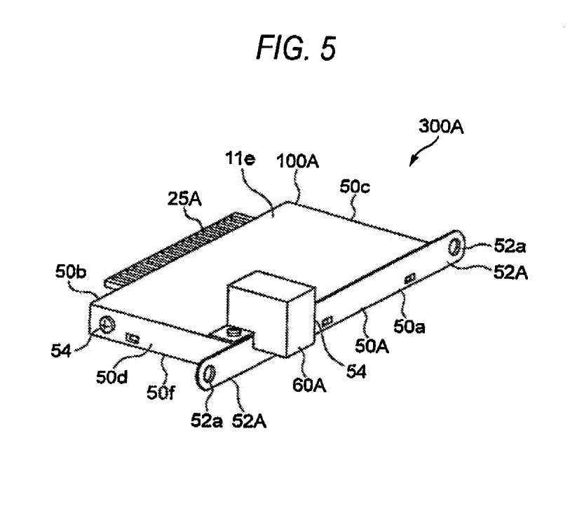

FIG. 5 is a perspective view of a tuner device 300A including a tuner module 100A that is mounted so as to elongate in a orthogonal to the major face of the main substrate according to the second embodiment of the invention.

In the illustrated tuner module 100A, the first case 11 and the second case (attachment case) 50A in the tuner module 100 are respectively used as an upper case and a lower case. A plurality of connector pins 25A mounted on the printed circuit board 20 extend in a direction perpendicular to the major face of the main substrate (in the horizontal direction).

The tuner module 100A includes an upper face, a lower face, a right side face, a left side face, a front face, and a rear face. That is, the tuner module 100A is box-shaped so as to have six faces.

The tuner device 300A is composed of a tuner module 100A including an attachment case 50A, a plurality of attachment pieces 52A extending from the attachment case 50A and mounting the tuner device 300A onto the cabinet (described later) of the car stereo device, and an RF connector 60A.

The attachment case 50A covers the front face, left side face, right side face, rear face, and bottom face (lower face) of the tuner module 100A. That is, the attachment case 50A is composed of a front plate part 50a defining the front face of the tuner module 100A, a left plate part 50d defining the left side face, a right plate part 50c defining the right side face, a rear plate part 50b defining the rear face, and a lower plate part 50f defining the bottom face (lower face). In other words, the attachment case 50A defines the tuner module 100A except the upper face 11e of the tuner module 100A.

Although the attachment case 50A covers five faces of the tuner module 100A in this embodiment, the attachment case 50A may cover at least one face thereof.

The attachment case 50A is mounted onto the tuner module 100A by using three screws 54 (only two of them are shown in FIG. 5). One of the three screws 54 is screwed into the front face of the tuner module 100A from the front plate part 50a of the attachment case 50A. Another screw is screwed into the left side face of the tuner module 100A from the left plate part 50d of the attachment case 50A. The remaining one screw (not shown) is screwed into the right side face of the tuner module 100A from the right plate part 50c of the attachment case 50A.

The attachment pieces 52A are arranged in two sections on the attachment case 50A. One of the two attachment pieces 52A extends leftward from the front plate part 50a of the attachment case 50A. The remaining one of the attachment piece 52A extends rightward from the front plate part 50a of the attachment case 50A. These attachment pieces 52A include through holes 52a for passing the screw parts of attachment screws described later.

The RF connector 60A is mounted on the tuner module 100A while protruding forward in the upper left section of the upper face 11e of tuner module 100A. Although the RF connector 60A is mounted on the upper face 11e of the tuner module 100A in this example, the RF connector 60A may be mounted on the lower plate part 50f of the tuner module 100A.

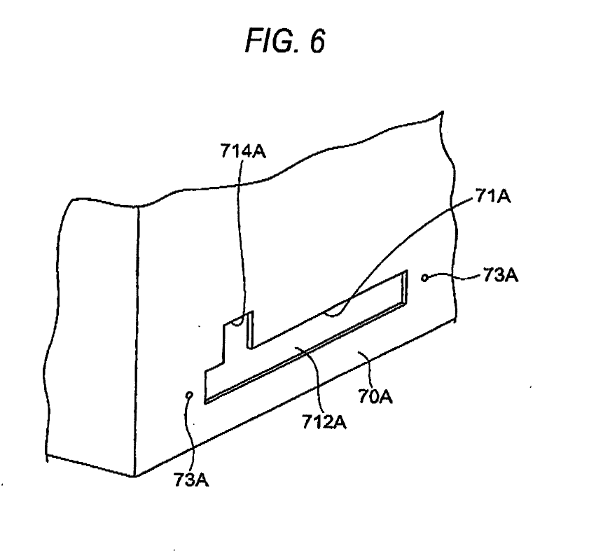

FIG. 6 is a partial schematic perspective view showing a part of the cabinet 70A of the car stereo device to which the tuner device 300A shown in FIG. 5 is retrofitted. The cabinet 70A of the car stereo device includes a slot 71A into which the tuner device 300A is inserted. That is, the slot 71A is composed of a cover inserting slot 712A having a shape corresponding to the external shape of the attachment case 50A and a connector inserting slot 714A having a shape corresponding to the external shape of the RF connector 60A. The cabinet 70A of the car stereo device includes two screw holes 73A bored in positions corresponding to the two attachment pieces 52A and into which attachment screws described later are screwed.

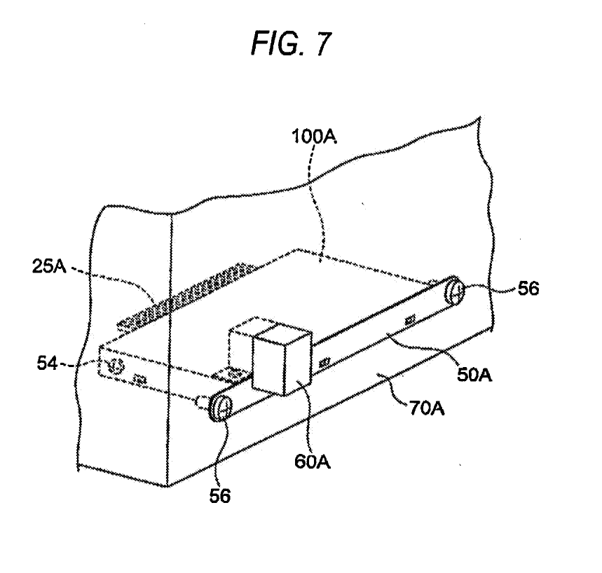

FIG. 7 is a perspective view of an arrangement where the tuner device 300A shown in FIG. 5 is mounted on the cabinet 70A of the car stereo device shown in FIG. 6. The tuner device 300A is retrofitted to the cabinet 70A of the car stereo device by screwing two attachment screws 56 into two screw holes 73A in the positions of the attachment pieces 52A while the tuner device 300A is inserted in the slot 71A on the cabinet 70A of the car stereo device. Accordingly, the connector pin 25A of the tuner module 100A is electrically connected to the major face of the main substrate (not shown) extending in perpendicular direction in the cabinet 70A of the car stereo device. The tuner device 300A is mounted on the cabinet 70A by inserting the tuner device 300A into the slot 71A on the cabinet 70A of the car stereo device by using the same arrangement as a slot in a personal computer (PC).

In view of the above, a combination of the attachment case 50A and the two attachment pieces 52A serves as a member for mounting the tuner device 300A onto the cabinet 70A of the car stereo device while the tuner device 300A is inserted in the slot 71A.

In this way, only the tuner device (satellite radio receiver module) 300A can be retrofitted to the cabinet 70A of the car stereo device. This enhances the development efficiency and production efficiency of a car stereo device compared with a car stereo device in which a satellite radio receiver module is incorporated in advance. This is because it is not necessary to develop/produce various types of car stereo devices. After purchasing an automobile, the user has only to purchase an antenna for SDARS and a tuner device (satellite radio receiver module) 300A in order to listen to satellite radio broadcasting. This eliminates the need for purchasing a whole car stereo device anew. With this arrangement, the tuner device 300A does not protrude outside the cabinet 70A except a part of the RF connector 60A, thus eliminating a useless mounting space.

A plurality of attachment screws 56 are used as fastening members for fastening the tuner device 300A onto the cabinet 70A. This readily removes the tuner device 300A from the cabinet 70A.

While a plurality of attachment screws 56 are used as fastening members for fastening the tuner device 300A onto the cabinet 70A in the second embodiment of the invention, the fastening member is not limited to a screw but various fastening means such as an adhesive may be used.

While the invention has been described in terms of preferable embodiments, the invention is by no means limited to the above embodiments.

While the invention is suitable for a tuner device in a vehicle mounted digital radio receiver that is especially requested to be compact, the invention is applicable to general radio receivers that allows a tuner device to be retrofitted to the cabinet of a car stereo device.

1. A tuner device comprising:
a tuner module, adapted to be retro-fitted into an opening formed on a cabinet of a car stereo device; and
an attachment member, provided on the tuner module and adapted to be used to attach the tuner device to the cabinet when the tuner module is retrofitted into the opening.

2. The tuner device as set forth in claim 1, wherein:
the tuner module is box-shaped; and
the attachment member comprises:
a cover defining at least a part of outer faces of the tuner module; and
a piece extended from the cover.

3. The tuner device as set forth in claim 2, wherein:
the piece is formed with a through hole and adapted to be placed at such a position that the through hole opposes a screw hole formed on the cabinet; and
the through hole is adapted to receive a screw to be screwed into the screw hole.

4. The tuner device as set forth in claim 2, wherein:
the cover comprises an outer face adapted to be placed on a plane which is parallel to a face of the cabinet formed with the opening; and the piece is extended from the outer face.

5. The tuner device as set forth in claim 4, further comprising:
a connector, attached to the tuner module and at least a part thereof is disposed on the outer face.

6. The tuner device as set forth in claim 1, further comprising:
a connector pin, attached to the tuner module and extending in a direction orthogonal to a circuit board disposed within cabinet when the tuner module is retro-fitted into the opening.

7. A car stereo device, comprising:
a cabinet formed with an opening; and
a tuner device comprising:
a tuner module retro-fitted into the opening; and
a first attachment member provided on the tuner module and attaching tuner module to the cabinet.

8. The car stereo device as set forth in claim 7, further comprising:
a second attachment member formed on the cabinet and. coupled with the first attachment member.

9. The car stereo device as set forth in claim 8, wherein:
the first attachment member includes a piece extended from the tuner module and formed with a through hole; and
the second attachment member includes a screw hole and a screw screwed into the screw hole through the through hole.

10. The car stereo device as set forth in claim 8, further comprising:
a circuit board extending in a first direction within the cabinet; and
a connector pin, provided with the tuner device and electrically connected to the circuit board, the connector pin extending in a second direction orthogonal to the first direction.

11. A car stereo device, comprising:
a cabinet formed with an opening adapted to receive a tuner module of a tuner device in a retro-fitting manner.

12. A method for mounting a tuner device onto a car stereo device, comprising:
providing the tuner device including:
a tuner module, adapted to be retro-fitted into an opening formed on a cabinet of a car stereo device; and
an attachment member, provided on the tuner module and adapted to be used to attach the tuner device to the cabinet when the tuner module is retro-fitted into the opening and the car stereo device as set forth in claim 11;
retro-fitting the tuner module into the opening; and
retaining the tuner module on the cabinet.
